(19) United States
(12) Patent Application Publication
(10) Pub. No.: US 2006/0155819 A1
(43) Pub. Date: Jul. 13, 2006

(54) Methods and system for using caches

(76) Inventors: Paul Lionel Grabinar, Reading (GB); Simon David Wood, Bracknell (GB)

Correspondence Address: MILLER JOHNSON SNELL CUMMISKEY, PLC, 800 CALDER PLAZA BUILDING, 250 MONROE AVE N W, GRAND RAPIDS, MI, 49503-2250, US

(21) Appl. No.: 10/516,140

(22) PCT Filed: May 27, 2003
(86) PCT No.: PCT/GB03/02280

§ 371 Date: Aug. 2, 2005

(30) Foreign Application Priority Data
May 29, 2002 (GB) 0212384.2

(51) Int. Cl. G06F 15/167

(52) U.S. Cl. 709/213

(57) ABSTRACT

A method of communicating data objects includes the steps of assembling at least one business object by a request server (225) from data held in a data store (230) in a remote information system (240) and storing a corresponding business object in a cache (210) in a local information processing device (235). A business object update message updates data held in the data store (230) or the cache (210). Furthermore, the cache stores at least one business object comprising a plurality of data objects as one retrievable entity. In this manner, business logic may be removed from an application and a cache, thereby making them easier to implement and increase the portability between the cache (210) and different data stores (130). Additionally, an improved cache management communications protocol removes the need for an application to recover from network problems, making the application easier to write.

### Field of the Invention

This invention relates to a mechanism for operating caches that store sub-sets of data and that are connected to a remote information store by a communication system whose performance (i.e. data rate, latency and error rate) varies with time. The invention is applicable to, but not limited to, a cache for use in a portable computer or similar device that can be connected to a corporate information system via a packet data wireless network.

### BACKGROUND OF THE INVENTION

Present day communication systems, both wireless and wire-line, have a requirement to transfer data between communication units. Data, in this context, includes many forms of communication such as speech, multimedia, signalling communication, etc. Such data communication needs to be effectively and efficiently provided for, in order to optimise use of limited communication resources.

For data to be transferred across data communication networks, a communication unit addressing protocol is required. In this regard, the communication units are generally allocated addresses that can be read by a communication bridge, gateway and/or router, in order to determine how to transfer the data to the addressed unit. The interconnection between networks is generally known as internetworking (or internet).

Networks are often divided into sub-networks, with protocols being set up to define a set of rules that allow the orderly exchange of information. Two common protocols used to transfer data in communication systems, are: Transmission Control Protocol (TCP) and Internet Protocol (IP). IP corresponds to data transfer in the network layer of the well-known OSI model whereas TCP corresponds to data transfer in the transport layer of the OSI model. Their operation is transparent to the physical and data link layers and can thus be used on any of the standard cabling networks such as Ethernet, FDDI or token ring.

In the field of this invention it is known that an excessive amount of data traffic routed over a core portion of a data network may lead to a data overload in the network. This may lead to an undesirable, excessive consumption of the communication resource, for example bandwidth in a wireless network. To avoid such overload problems, many caching techniques have been introduced to manage the data traffic on a time basis.

An example of a cache, which may be considered as a local storage element in a distributed communication or computing system, includes network file systems, where data retrieved from a file storage system (e.g. a disk) can be stored in a cache on the computer that is requesting the data.

A further example is a database system, where data records retrieved from the database server are stored in a client's cache. Furthermore, web servers are known to cache identified web pages in network servers closer to a typical requesting party. Web clients (browsers) are also known to cache previously retrieved web pages in a store local to the browser. As the information age has continued apace, the benefits and wide-use of caches has substantially increased.

Referring now to FIG. 1, a known data communication system 100 is illustrated that employs the use of a cache 110 to store data locally. A local information processing device 135, such as a personal digital assistant or wireless access protocol (WAP) enabled cellular phone, includes a communication portion 115, operably coupled to a cache 110. The device 135 also includes application software 105 that cooperates with the cache 110 to enable the device 135 to run application software using data stored in, or accessible via, the cache 110. A primary use of the cache 110 is effectively as a localised data store for the local information-processing device 135.

The communication portion 115 is used to connect the cache to remote information system 140, accessible over a communication network 155. In this regard, as well as for many other applications, caches are often used to reduce the amount of data that is transferred over the communication network 155. The amount of data transfer is reduced if the data can be stored in the cache 110 on a local information-processing device 135. This arrangement avoids the need for data to be transferred/uploaded to the local information-processing device 135, from a data store 130 in a remote information system 140, over the communication network 155 each time a software application is run.

Furthermore, in general, caches provide a consequent benefit to system performance, as if the data needed by the local information-processing device 135 is already in the cache 110 then the cached data can be processed immediately. This provides a significant time saving when compared to transferring large amounts of data over the communication network 155. In addition, caches improve the communication network's reliability, because if the communication network fails then:
(i) The data in the cache 110 is still available, allowing processing in the local information-processing device 135 to continue to the extent possible given the extent of the data in the cache 110; and
(ii) The application in the local information-processing device 105 can create new items or modify existing items in the cache, which can then be used to update the remote information system 140.

In the current state of the art, caches store low-level data elements and leave it to the application 105 to re-assemble the stored data into a meaningful entity. For example, customer records in a database are stored as rows in the customer table, but addresses are often stored as rows in the address table. In this example, the customer table row has a field that indicates which row in the associated address table is the address for that particular customer. The cache 110 would likely be configured to have the same structure as the database, replicating the table rows that relate to the objects that it holds. The inventors of the present invention have recognised inefficiencies and limitations in organising objects within caches in this manner, as will be detailed later.

Furthermore, the application 105 generally contains considerable business logic (matching that in the data store) to be able to interpret the data elements in the cache 110 and to operate on them correctly.

In addition, the cache 110 must make sure that updates of objects maintain “transactional integrity”. This means that if an object comprises rows from three tables, and an operation by the application 105 changes elements in all three rows, then the corresponding three rows in the data server must all be updated before any other application is allowed to access that object. If this transactional integrity is not maintained then objects will contain incorrect data, because some fields will have been updated and others will have not.

Clearly, as the application 105 must therefore contain all of the business logic needed to interpret and maintain consistency of the low level data in the cache, it is complex to build. Furthermore, there is complexity and data integrity implications associated with updating the business logic on the data store. This consumes memory and processing power on the local information-processing terminal 135. For portable (battery-operated) computing terminals, this last point is particularly disadvantageous as minimising power and resource consumption is of paramount importance.

Wireless communication systems, where a communication link is dependent upon the surrounding (free space) propagation conditions, are known to be occasionally unreliable. Hence, the need to maintain transactional integrity over unreliable communication networks means that specially designed, complicated protocols are needed. Such protocols need to hold the state of any transaction that is in progress should the local information processing device become disconnected from the communication network for any length of time (for example if a wireless device moves into an area with no radio coverage). Once re-connected the transactions that were in progress must then be completed.

Thus, there exists a need to provide an improved organisation of data objects within a cache, wherein the aforementioned problems are substantially alleviated.

In the context of cache usage, it is important to be able to retrieve lists of items as quickly and efficiently as possible. For example, a user may perform a search, for example, to find all customers whose name begins with “T”. It is important to the user that the retrieval of this data list is performed quickly. Current cache-based applications 105 retrieve these lists by sending a request to a server 125 on a remote information system 140 for the search to be carried out. The server 125 then returns the entire list. Clearly, such lists are also returned for other purposes. These lists often require large amounts of data, the processing of which consumes a lot of power.

Frequently the cache 110 already contains some of the objects that will be returned with the entire retrieved list, following a request. For example, where a list includes all the sales leads for a customer, and this list has previously been downloaded. When asking for all the leads again, the request must be made on the data store 130 as there may have been new leads added since the last find. However, the inventors of the present invention have recognised that even if one or two new leads have been added, most will still exist in the cache and will still be valid. Nevertheless, by requesting all leads from the data store 130, the current list retrieval techniques ignore any data items from the list that already exist in the cache. This inefficiency means that there are unnecessary data transfers over the communication network 155, which further reduce performance and increase costs.

Thus, there also exists a need to provide an improved mechanism for retrieving data objects from within a cache, wherein the aforementioned problems are substantially alleviated.

One benefit of some cache designs is that data items can be created and updated within the cache 110, and only later are new or modified items ‘flushed’ to the remote information store 140. Examples include network file systems and database systems. Notably, the caches used in web browsers do not have this capability. In order to maintain transactional integrity, once the cache begins to update the remote information system with the changed items, the system does not allow any of those items to be updated in the cache 110 by the using application 105 until all remote updates have been completed.

Locking the cache 110, while updates to the data store 130 are in progress, is acceptable if the update is quick and reliable, for example over a high speed LAN or direct serial connection to a PC. However, if the update is slow and unreliable, as is typically the case over a wireless communication network, then this method can block use of the application 105 for a considerable time. This restricts the utility of the application 105 to the device user.

Thus, there also exists a need to provide an improved mechanism for updating data objects to a remote information store, wherein the aforementioned problems associated with locking the cache are substantially alleviated.

As indicated, a communications protocol must be run over the communication network to define the information to be retrieved as well as to recover from any network problems. Current cache management communications protocols 145 are designed for wireline networks.

Examples of such protocols include:
(i) Server Message Block (SMB), which is the Windows file management protocol, runs over TCP/IP;
(ii) Network File System (NFS), which is the UNIX file management protocol, runs over UDP/IP;
(iii) Hyper Text Transfer Protocol (HTTP), which is the web page retrieval protocol, runs over TCP/IP; and
(iv) Distributed Component Object Model (DCOM), which is a remote method invocation protocol, runs over TCP/IP.

However, if the communication network suffers degradation in service or a total failure, which is a common occurrence in the types of wireless networks that this invention serves, the request for data can often not be satisfied. Current cache management communications protocols (SMB, NFS, HTTP, DCOM etc) do not store the request nor do they re-transmit the request when the network is re-connected. Instead, the application must carry out an extensive recovery procedure, which often results in a further attempt to obtain the data after a suitable pre-defined interval. Unfortunately, this means that the application writer needs to be aware of how the underlying communications system operates and accordingly write the program code needed to effect and manage the re-tries.

If different applications use the same cache or cache structure, then each one must implement the re-try mechanisms. This means that the applications themselves have additional complexity and hence required extra development and test time.

A need therefore also exists for an improved cache management communications protocol wherein the abovementioned disadvantages associated with prior art arrangements may be alleviated.

### STATEMENT OF INVENTION

In accordance with a first aspect of the present invention, there is provided a method of communicating data objects across a data communication network, as claimed in Claim 1.

In accordance with a second aspect of the present invention, there is provided a cache, as claimed in Claim 7.

In accordance with a third aspect of the present invention, there is provided a request server, as claimed in Claim 15.

In accordance with a fourth aspect of the present invention, there is provided a cache management communications protocol, as claimed in Claim 18.

In accordance with a fifth aspect of the present invention, there is provided a request server, as claimed in Claim 25.

In accordance with a sixth aspect of the present invention, there is provided a local information processing device, as claimed in claim 26.

In accordance with a seventh aspect of the present invention, there is provided a remote information system, as claimed in Claim 27.

In accordance with an eighth aspect of the present invention, there is provided a communication network, as claimed in claim 28.

In accordance with a ninth aspect of the present invention, there is provided a request server, as claimed in Claim 31.

In accordance with a tenth aspect of the present invention, there is provided a local information processing device, as claimed in claim 32.

In accordance with an eleventh aspect of the present invention, there is provided a remote information system, as claimed in Claim 33.

In accordance with a twelfth aspect of the present invention, there is provided a method for a local information processing device having a cache to retrieve at least one data object from a remote information system, as claimed in Claim 34.

In accordance with a thirteenth aspect of the present invention, there is provided a storage medium, as claimed in Claim 40.

In accordance with a fourteenth aspect of the present invention, there is provided a local information processing device, as claimed in claim 41.

In accordance with a fifteenth aspect of the present invention, there is provided a cache, as claimed in Claim 42.

Further aspects of the present invention are as claimed in the dependent claims.

The preferred embodiments of the present invention address the following aspects of cache operation and data communication networks. In particular, the inventive concepts described herein find particular applicability in wireless communication systems for connecting portable computing devices having a cache to a remote data source. The inventive concepts address problems, identified by the inventors, in at least the following areas:
(i) Organisation of objects within the cache;
(ii) Retrieving lists of data items;
(iii) Updating the cache when previous updates are being flushed; and
(iv) Cache management communications protocol to update the cache.

### BRIEF DESCRIPTION OF THE DRAWINGS

FIG. 1 illustrates a known data communication system, whereby data is passed between a local information processing device and a remote information system.

Exemplary embodiments of the present invention will now be described, with reference to the accompanying drawings, in which:

FIG. 2 illustrates a functional block diagram of a data communication system, whereby data is passed between a local information processing device and a remote information system, in accordance with a preferred embodiment of the present invention;

FIG. 3 illustrates a preferred message sequence chart for retrieving a data list from a cache, in accordance with the preferred embodiment of the present invention;

FIG. 4 illustrates a functional block diagram of a cache management communication protocol, in accordance with the preferred embodiment of the present invention;

FIG. 5 illustrates the meanings of the terms “message”, “block” and “packet” as used within this invention;

FIG. 6 shows a flowchart illustrating a method of determining an acceptable re-transmit time, in accordance with the preferred embodiment of the present invention; and

FIG. 7 shows a flowchart illustrating a method of determining an acceptable re-transmit time, in accordance with an alternative embodiment of the present invention.

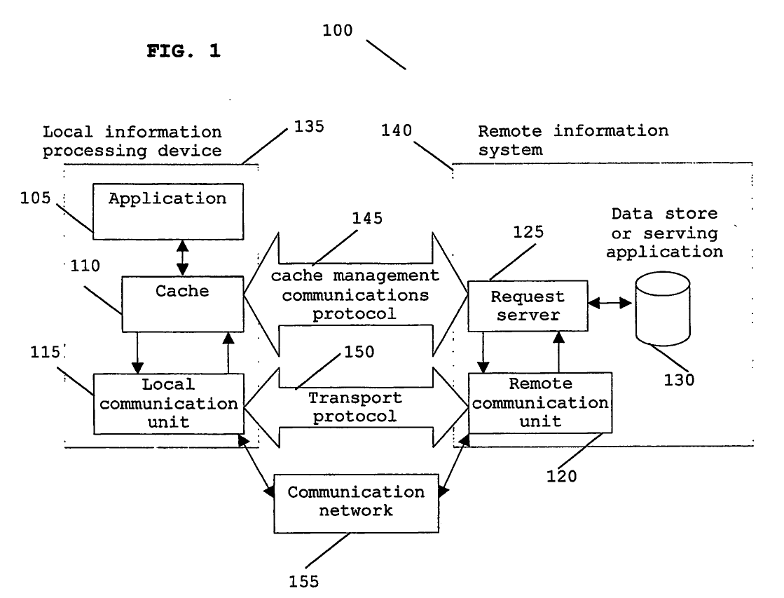

### DESCRIPTION OF PREFERRED EMBODIMENTS

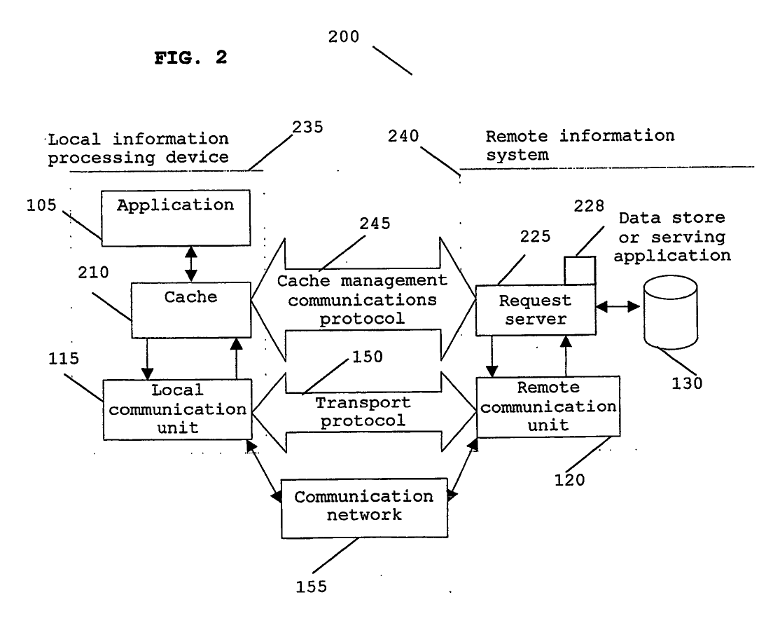

Referring next to FIG. 2, a functional block diagram 200 of a data communication system is illustrated, in accordance with a preferred embodiment of the present invention. Data is passed between a local information processing device 235 and a remote information system 240, via a communication network 155. The preferred embodiment of the present invention is described with reference to a wireless communication network, for example one where personal digital assistants (PDAs) communicate over a GPRS wireless network to an information database. However, it is within the contemplation of the invention that the inventive concepts described herein can be applied to any data communication network—wireless or wireline.

Notably, in the preferred embodiment of the present invention, a single data object is used to represent a complete business object rather than part of a business object with external references to the other components of the object. In the context of the present invention, the term ‘business object’ is used to encompass data objects from say, a complete list of Space Shuttle components to a list of customer details. An example of a business object could be an XML fragment defining a simple customer business object as follows

<customer>

<name>

“Company name”

</name>
<mailing address line1>

“mailing address line 1”

</mailing address line1>
<mailing address line2>

“mailing address line 2”

</mailing address line2>
<delivery address linel>

“delivery address line 1”

</delivery address line1>
<delivery address line2>

“delivery address line 2”

</delivery address line2>

</customer>

Where the tagged items are referred to as “properties”.

In accordance with the preferred embodiment of the present invention, the request server 225 has been adapted to contain a logic function 228 that creates each business object from the various tables of data stored within the associated data store 130 in the remote information system 240. This logic function 228 is specific to the data store 130 and/or the structure of the data it contains.

Business objects are then passed between the cache 210 and the request server 225.

If a new object is created, or the properties of an existing object are changed, the cache 210 passes the changed properties back to the request server 225. Advantageously, in accordance with the preferred embodiment of the present invention, the logic function 228 performs the required updates on the appropriate table rows in the database within the data store 130. Thus, the application 105 and cache 210 are shielded from needing to know anything about how the data is stored on the data store 130. Advantageously, this makes the task of the application writer much easier. Furthermore, by enabling the cache 210 to pass the changed properties back to the logic function 228 in the request server 225, it is easier to connect the local information processing device 235 to a different type of data store 130, simply by re-writing the logic function 228 in the request server 225.

It is also within the contemplation of the invention that an extra property can be added to an object for the application to use. A corresponding extra property of the object needs to be added to the logic function 228 in the request server 225. Advantageously, the provision of the logic function 228 ensures that no changes are needed in the cache 210, because the cache 210 is just a general purpose store that saves lists of objects, objects and object properties, without knowing how the three types of entity interrelate other than by data contained within the entities themselves. For example, an object list entity contains a list of the unique identity numbers of the business objects in the list; an object contains a list of the unique identity numbers of the properties in the object.

When carrying out updates the cache 210 preferably sends all the changed properties to the remote request server 225 in one update message. The update message is either received successfully or it is not received at all. Hence, there is no possibility that only some of the updates will be received. In this manner, transactional integrity of the data is guaranteed.

Notably, in accordance with the preferred embodiment, updates made by the application 105 to existing objects in the cache 210 do not update the cached object, but are attached to the object as an update request. When the local information-processing device 235 is operably coupled to the remote information system 240, for example, when the wireless device 235 is within coverage range of the wireless information system 240, update requests are sent to the request server 225. The request server 225 then updates the data store 130.

Once the request server 225 receives a confirmation from the data store 130 that the update request has been successful, the request server 225 signals to the cache 210 that the update request was successful. Only then does the cache 210 update its copy of the object. Hence, advantageously, the cache 210 can be synchronised to the data store 130 on the remote information system 240. In this manner, the application 105 is able to modify objects in the cache 210 that have already been changed, during the time that change is being implemented in the data store 130.

Until this success confirmation is received, the update request is preferably marked as “in progress”.

If a further update is made by the application 105 to a property that has an “in progress” update request, it is envisaged that the second update is attached to the first update request as a ‘child’ update request. In accordance with the preferred embodiment of the present invention, the cache 210 has been adapted to include logic that ensures that this child update request commences only after the ‘parent’ update request has completed successfully. If a further update is made by the application 105, whilst the current child update request has not yet been effected, the further update is preferably merged with the current child update request.

When the application 105 requests a data object from the cache 210, the cache 210 carries out the following steps:
(i) Reads the properties from the cached object;
(ii) Applies any updates from an attached update request to the properties;
(iii) Applies any further updates from an attached child update request to the properties; and
(iv) Returns the updated object to the application.

More generally, it is envisaged that the aforementioned processing or memory elements may be implemented in the respective communication units in any suitable manner. For example, new apparatus may be added to a conventional communication unit, or alternatively existing parts of a conventional communication unit may be adapted, for example by reprogramming one or more processors therein. As such, the required implementation (or adaptation of existing unit(s)) may be implemented in the form of processor-implementable instructions stored on a storage medium, such as a floppy disk, hard disk, PROM, RAM or any combination of these or other storage multimedia.

In the case of other network infrastructures, wireless or wireline, implementation of the processing operations may be performed at any appropriate node such as any other appropriate type of server, database, gateway, etc. Alternatively, it is envisaged that the aforementioned operations may be carried out by various components distributed at different locations or entities within any suitable network or system.

It is further envisaged that the applications that use caches in the context hereinbefore described, will often be ones in which a human user requests information from the data store (or serving application) 130. The application 105 will then preferably display the results of the data retrieval process on a screen of the local information processing device 235, to be viewed by the user.

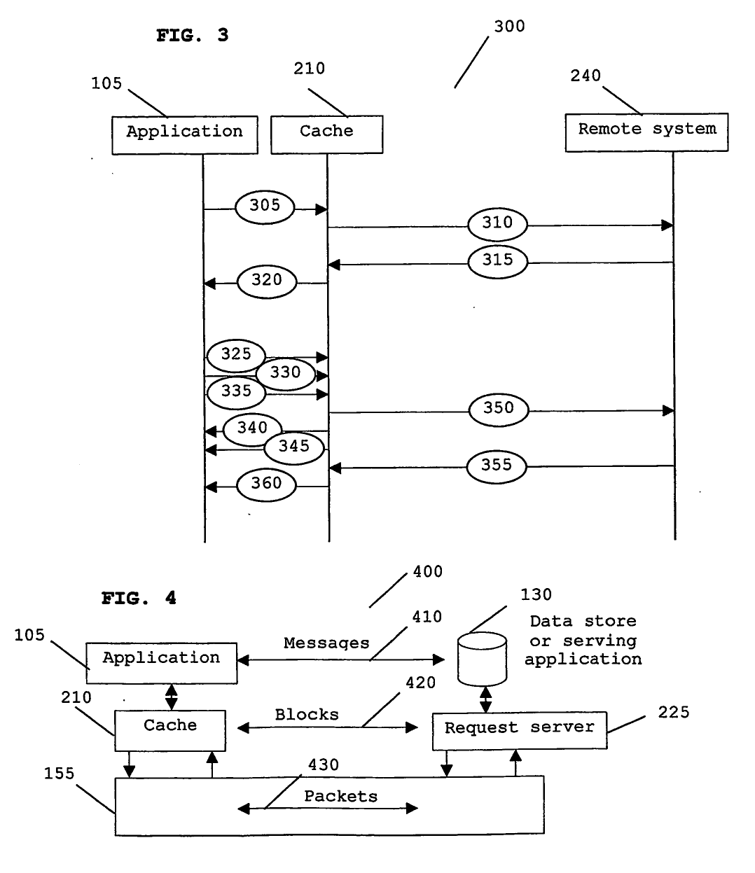

Referring now to FIG. 3, a message sequence chart 300 for retrieving a data list from a remote information system 240 via a cache 210 is illustrated, in accordance with the preferred embodiment of the present invention. The message sequence chart 300 illustrates messages between the software application 105, the cache 210 and the remote information system 240.

The application 105 makes a request 305 for a data object list from the cache 210. If the communication network is operational, the cache 210 makes a corresponding request 310 to the remote system 240 for the IDs of all the objects that are contained within the list. Once the cache 210 receives the ID list 315 it forwards the ID list 320 to the application 105.

For example, if the list contains three IDs then the application 105 then makes three individual requests 325, 330 and 335 to the cache 210 for each object whose ID was returned in the list. In this example, let us assume that valid copies of the first and second objects, relating to request 325 and 330 first and second objects are already in the cache 210.

In accordance with the preferred embodiment of the present invention, the cache is configured to recognise that the first and second requested data objects are stored within the cache 210. Advantageously, the first and second requested data objects are then returned directly 340 and 345 to the application 105 from the cache 210. However, the cache 210 recognises that no valid copy of the third object is contained in the cache 210. Hence, the cache 210 requests a copy 350 of the third object from the remote information system 240. Once the cache receives the copy 355 of the third object, the cache 210 passes the third object 360 to the application 105.

In this manner, retrieval of a desired list of objects is performed efficiently and effectively, by utilising existing data object stored in the cache 210. Furthermore, utilisation of the communication network is kept to a minimum, where it is limited to the initial list request 310, 315, and retrieval of a data object 350, 355 that was not already stored in the cache 210.

Although FIG. 3 illustrates the first and second objects being sent to the application 105 from the cache 210 after the request 350 has been sent to the information system 240, a skilled artisan would appreciate that such transmission of data objects may be sent immediately, whilst a resource is being accessed on the communication network to request the third data object.

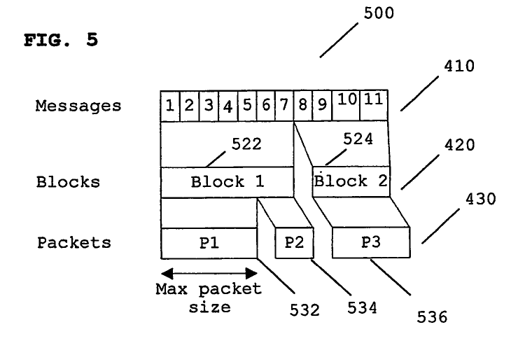

Referring now to FIG. 4, a functional block diagram of a cache management communication protocol 400 is illustrated, in accordance with the preferred embodiment of the present invention. The cache management communications protocol 400 preferably includes a variable block size and a variable re-transmit time. The cache management communications protocol 400 is also preferably symmetric between the two communicating entities.

In the following explanation, communications from the cache 210 to the request server 225 are described, for clarity purposes only. Communications from the request server 225 to the cache 210 are, substantially identical in form, except that all data flows in the opposite direction to that described here.

The cache management communications protocol 400 passes blocks of data that include one or more messages between the cache 210 and the request server 225. The cache management communications protocol 400 operates on a transport protocol 150 that runs within the communication network 155. The transport protocol 150 carries the data blocks 420 in one or more packets 430, depending on the relative sizes of the block and the packets, as shown in greater detail with respect to FIG. 5.

To use the cache management communications protocol 400 described in this invention, the transport protocol 150 and communication network components 155 preferably has one or more of the following capabilities:
(i) The ability to wrap the data block in one packet or, if the data block is larger than the largest packet the transport protocol 150 allows, in multiple packets;
(ii) Route the packets 430 from the source to the destination;
(iii) If the data block 420 was passed in more than one packet 532, 534, re-assemble the data block from its constituent packets; and
(iv) Detect and delete data blocks duplicated in the communication network 155.

In the preferred embodiment, the transport protocol 150 has the following further characteristics, singly or preferably in combination, in order to optimise use of the cache management communications protocol 400:
(i) Packets lost from multi-packet data blocks are detected and re-transmitted without involvement of the cache 210 or request server 225;
(ii) The communication network components in the local information-processing device 235 and the remote information system 240 estimate the likely transmission time for each packet and the current communication network bit rate. The local information-processing device 235 and the remote information system 240 then pass this information to their respective users, the cache 210 or request server 225;
(iii) The communication network components in the local information-processing device 235 and the remote information system 240 are configured to inform their respective users, the cache 210 or request server 225, when transmission of a message commences.

The only protocol known to possess all these features is the Reliable Wireless Protocol developed by flyingSPARK™. However, it is envisaged that the inventive concepts related to the cache management communication protocol, as described herein, may be applied to any transport protocol, such as the Wireless Transport Protocol (WTP), which is part of the Wireless Access Protocol (WAP) protocol suite.

For improved efficiency on the communication network 155, it is preferred that the transport protocol 150 does not run in an ‘acknowledged’ mode. In this regard, the acknowledgment of a request message from the cache 210 equates to the response message received from the request server 225. The approach to using a response message as an acknowledgement removes the need for any additional acknowledgements to be sent by the transport protocol 150.

In this regard, as the cache 210 receives no explicit acknowledgement that the data block that was sent has been received at the request server 225, the cache 210 needs to track what blocks have been sent. If no response message is received within a defined time for any of the request messages within the block, then that block is identified as lost. The block is then preferably re-transmitted by the cache 210. In order for the cache 210 not to re-transmit blocks unnecessarily, but to re-transmit them as soon as it is clear that the response has not been received by the request server 225, the cache 210 needs to estimate the time within which a response would be typically expected. In a typical data communication environment, such as a packet data wireless network, this time will depend on a number of the following:
(i) The available bandwidth of the network,
(ii) The loading on the channel,
(iii) The size of the block of data transmitted, and
(iv) The amount of processing in the remote information system 240 to retrieve the data requested.

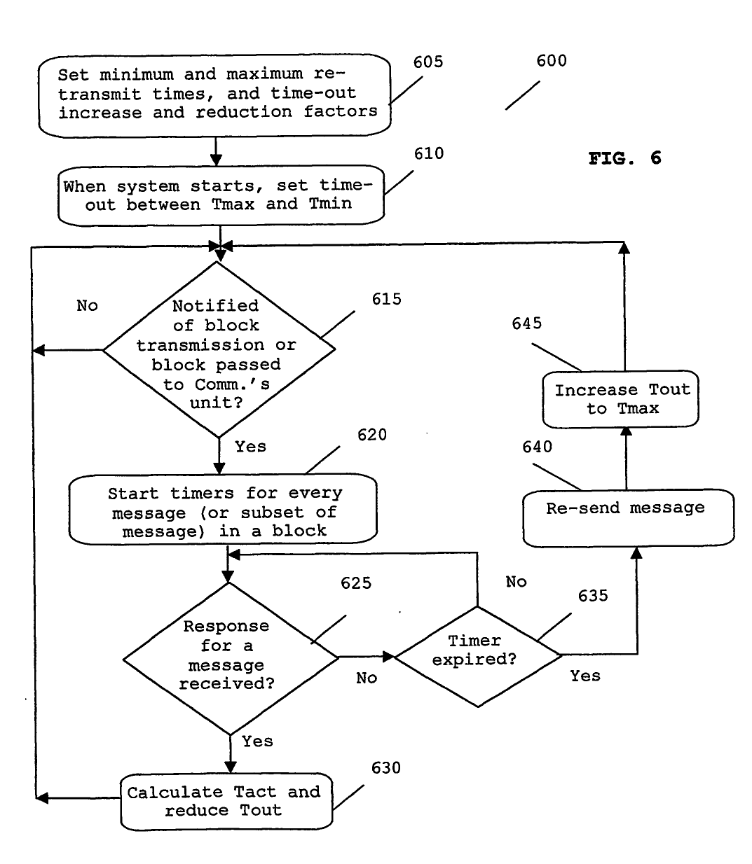

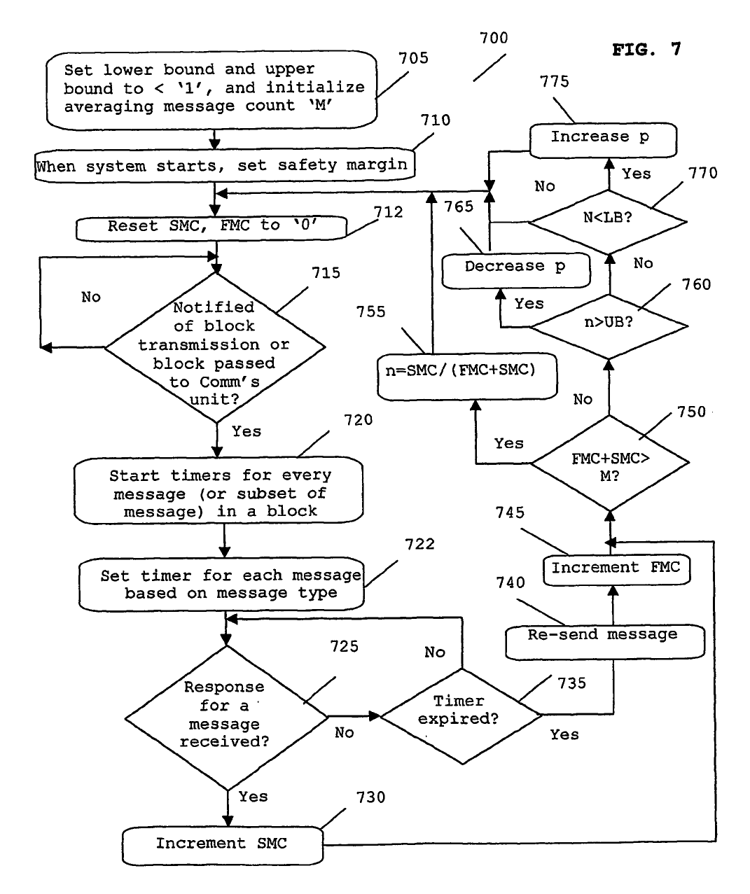

Two preferred examples, for determining an acceptable re-transmit time within the cache management communications protocol 400 are described with reference to FIG. 6 and FIG. 7. The descriptions detail information flow from the cache 210 to the request server 225. However, the same descriptions apply equally well to information flow from the request server 235 to the cache 230, albeit that data flows in the reverse direction and the actions of the cache 230 and the request server 235 are swapped.

Referring now to FIG. 6, a flowchart 600 indicating one example for determining an acceptable re-transmit time is illustrated. First, a minimum re-transmit time (Tₘᵢₙ), a maximum re-transmit time (Tₘₐₓ), a time-out reduction factor α and a time-out increase factor β, are set in step 605, where α and β are both less than unity. When the system starts, the time-out (Tₒᵤₜ) is set to the mid-point between Tₘₐₓ and Tₘᵢₙ, as shown in step 610.

When notified by the local communication unit 115 that transmission of a data block has started or, in the absence of this capability, when the data block is passed to the local communications unit 115 in step 615, a timer for substantially each message (or a subset of messages) that is included in the block is commenced in the Cache 230, as in step 620. If a response for a message is received before the timer expires in step 625, the actual time, T_{act}, that the request-response message pair took is calculated. In addition, Tₒᵤₜ is reduced to:
(1−α)·Tₒᵤₜ+α·T_{act} [1]
down to a minimum of Tₘᵢₙ, as shown in step 630.

If the timer expires in step 635, the message is re-sent in step 640. Tₒᵤₜ is then increased to:
(1+β)·Tₒᵤₜ [2]
up to a maximum of Tₘₐₓ, as shown in step 645.

In this manner, the re-transmit timer is adaptively adjusted, using α and β based on the prevailing communication network conditions.

Although not indicated in the above example, it is envisaged that a re-transmit timer margin may be incorporated, whereby an increase or decrease in Tₒᵤₜ would not be performed. In this manner, the method has an improved chance of reaching a steady state condition.

It is envisaged that Tₘᵢₙ, Tₘₐₓ, α and β may be selected based on theoretical studies of the cache management communications protocol 400. Alternatively, or in addition, they may be selected based on trial and error when running each particular implementation.

Referring now to FIG. 7, a flowchart 700 indicating a second example for determining an acceptable re-transmit time, is illustrated. This example assumes that the local communication unit 235 and remote information system 240 can provide continually-updated estimates of the transmission time in both directions (Tᵤₚ and T_{down}) for maximum-sized packets. Furthermore, it is assumed that the application 105 is able to provide an estimate, T_{proc}, of the processing time of each request type at the data store (or serving application) 130.

First, a lower bound (LB) and an upper bound (UB) are set to the acceptable levels of the proportion of packets that are re-transmitted, where LB and UB are greater than zero and less than unity. In addition, an averaging message count M is initialised, where M is an integer greater than zero, as shown in step 705. When the system starts, a safety margin ρ is set to a suitable value, say 0.5, as in step 710. A successful message counter (SMC) and a failed message counter (FMC) are then set to zero, as shown in step 712.

When notified by the local communication unit 235 that transmission of a block has started or, in the absence of this capability, when the block is passed to the local communication unit 235 in step 715, a timer for substantially each message (or a subset of messages) included in the data block are commenced as shown in step 720. The timers are set separately for each message, to:
(1+ρ) (Tᵤₚ+T_{down}+T_{proc}) [3]

Where the T_{proc} is specific to that message type, as shown in step 722.

If a response is received in step 725 before the timer expires, the SMC value is incremented, as shown in step 730. If the timer expires in step 735, the message is re-sent in step 740 and FMC incremented, as shown in step 745.

The sum of FMC+SMC is then calculated, and if the sum is determined to be greater than ‘M’ in step 750, then the success ratio (η) is set, in step 755, to:
η=SMC/(FMC+SMC) [4]

In this regard, either FMC or SMC is incremented each time a message is sent, so FMC+SMC is the total number of messages sent (including retries) since they were zeroed. Thus, η is the proportion of messages that are sent successfully.

If η>UB in step 760, then ρ is decreased to ρ.UB/η, as shown in step 765. However, if η<LB in step 770, then ρ is increased to ρ.LB/η, as shown in step 775. The process then returns to step 712 whereby FMC and SMC are reset.

It is envisaged that the values for LB, UB, and M may also be selected based on theoretical studies of the cache management communications protocol 400. Alternatively, or in addition, they may be selected based on trial and error when running each particular implementation.

As shown in FIG. 4, the fundamental unit of data passed between the application 105 and the request server 225 is a message. These messages may contain requests for data (an object or a list of objects), replies to requests (responses containing one or more or a list of objects), updates of data that already exist, etc. It is envisaged that each message may be a different size. Frequently a group of messages will be sent out together, concatenated into a single block of data, as shown in FIG. 5. In this regard, the cache 210 groups messages together into the optimum size of data block.

When the communications reliability is high, large blocks should be sent in order to:
(i) Minimise the overhead needed,
(ii) To provide a more rapid transmission, and
(iii) Provide a more efficient use of the communication network 155.

When reliability is low, and blocks need to be re-transmitted, blocks should be small to reduce the probability that an individual block is corrupted. The block size should also be kept small to reduce the amount of data that needs to be re-sent in the event of a corrupted block.

Current cache management communications protocols do not have these features. The preferred embodiment of the present invention provides a mechanism to address these deficiencies. A preferred algorithm for achieving this adaptive block size is described below.

First, let us set an upper bound (UB) and a lower bound (LB) to the number of messages that may be contained in a block. When the system starts, the Block Size (BS) is set to the mid point between UB and LB.

If a block is sent successfully, then the BS is increased by a Success Increment (SI) up to a maximum of UB. In this context, ‘sent successfully’ means one of the following:
(i) A response was received for at least one of the messages in the block (this is relevant when using an unacknowledged transport protocol 150); or
(ii) There was no notification from the communication network 155 that the block was not received successfully (this is relevant when using an acknowledged transport protocol 150).

If a block is re-transmitted, then the BS is reduced by a Failure Decrement (FD) value, down to a minimum of LB.

Although not indicated in the above example, it is envisaged that a data block size margin may be incorporated, whereby an increase or decrease in BS would not be performed. In this manner, the method has an improved chance of reaching a steady state condition.

When presented with a set of messages from the application 105, the cache 230 groups a BS number of messages into each block. It is envisaged that UB, LB, SI and/or FD may be selected based on theoretical studies of the cache management communications protocol and/or by trial and error in each particular implementation.

An optional enhancement to the above block size selection algorithm is to set UB as being dependent upon the available communication network bit rate, as notified by the local communication unit 115. When bit rates are high, UB may be set at a higher level to take advantage of the higher available bandwidth. When bit rates are low, UB should be reduced to a value that ensures that the round trip time for a request/response is sufficiently short so that the user will still experience an acceptable response time from the system.

If a large number of data requests and response messages are sent in a block, the remote information system 240 may appear to the user to be relatively unresponsive. In order to improve the responsiveness of the remote information system 240, for large collections of data request messages, the preferred embodiment of the present invention limits the first transmitted block to a small number of messages. This number may be a fixed value, defined for each implementation, or it may be specified by the application. As such, the number may be adjusted depending on, inter-alia:
(i) The type of the request,
(ii) Any preferences set by the user, and
(iii) The task that the user is currently performing.

Advantageously, this technique ensures that the first few requested objects are retrieved quickly. Thus, a small part of the list appears quickly on the screen, providing the user with good feedback and a speedy indication that the system is working and is responsive.

It will be understood that the data communication system described above provides at least the following advantages:

With regard to organisation of data objects within a cache:
(i) All business logic is removed from the application and cache, thereby making them easier to implement and increase the portability between the cache 210 and different data stores 130;
(ii) The cache and application are isolated from any changes to the structure of the data in the data store 130, thereby making it easier to upgrade the data store; and
(iii) Transactional integrity is improved.

With regard to the retrieval of lists of items:
(i) The amount of data sent over the communication network is kept to a minimum; and
(ii) A rapid response to the user is provided, by displaying items available from the cache immediately on a communication unit's screen.

With regard to updating the cache when previous updates are being flushed:
(i) The application 105 is allowed to keep on using and modifying data in the cache 210, even during extended data store update periods, by use of an attached update request; and
(ii) Transactional integrity is improved.

With regard to the provision of an improved cache management communications protocol:
(i) The need for the application to recover from network problems is removed, thereby making the application easier to write;
(ii) The communication demand is varied to match the communication network's capabilities; thereby maximising data transfer performance;
(iii) Ensures that the response from the request server occurs in a reasonable time to allow the application to provide good user feedback; and
(iv) Ensures a quick turn round of the initial data items in a list, to allow the application to provide good user feedback.

Whilst the specific and preferred implementations of the embodiments of the present invention are described above, it is clear that one skilled in the art could readily apply variations and modifications of such inventive concepts.

Thus, an improved mechanism for organising data objects within a cache has been described wherein the abovementioned disadvantages associated with prior art arrangements have been substantially alleviated.

Furthermore, an improved mechanism for retrieving data objects from within a cache has been described, wherein the abovementioned disadvantages associated with prior art arrangements have been substantially alleviated.

Moreover, an improved mechanism for updating data objects to a remote information store has been described, wherein the abovementioned disadvantages associated with prior art arrangements have been substantially alleviated.

In addition, an improved cache management communications protocol has been described, wherein the abovementioned disadvantages associated with prior art arrangements have been substantially alleviated.

1. A method of communicating data objects across a data communication network between a cache (210) in a local information processing device (235) and a request server (225), operably coupled to a data store (130), in a remote information system (240), the method characterised by the steps of:
assembling at least one business object by said request server (225) from data held in said data store (130);
storing a corresponding at least one business object in said cache (210); and
communicating at least one business object update message between said cache (210) and said request server (225) to update data held in said data store (130) or said cache (210), wherein said at least one business object update message substantially comprises only one or more change to said data.

2. The method of communicating data objects across a data communication network according to claim 1, wherein said step of communicating includes communicating a single business object update message containing substantially all changes to said at least one business object thereby maintaining data integrity between said cache (210) and said data store (230).

3. The method of communicating data objects across a data communication network according to claim 1 or claim 2, wherein said cache (210) is operably coupled to an application (105), the method further characterised by the step of:
requesting, by said application (105), a data update relating to said at least one business object in said request server (225);
attaching an update request to said at least one business object update message by said cache (210).

4. The method of communicating data objects across a data communication network according to claim 3, the method further characterised by the step of:
receiving said update request attached to said at least one business object update message by said request server (225); and
updating said data store (230) with said update.

5. The method of communicating data objects across a data communication network according to claim 4, the method further characterised by the step of:
informing said cache (210) by said request server (225) when said update of said data store has been completed; and
updating said cache (210) with said update request in response to said step of informing.

6. The method of communicating data objects across a data communication network according to claim 3, the method further characterised by said cache (210) performing the following steps:
reading properties from the requested cached object;
applying any updates from an attached update request to the properties;
applying any further updates from an attached child update request to the properties; and
returning the updated object to the application (105).

7. A cache (210) for use in a local information processing device (235), said cache characterised in that said cache stores at least one business object comprising a plurality of data objects as one retrievable entity.

8. The cache (210) according to claim 7, wherein said at least one business object includes one or more of the following: one or more lists of objects, objects and/or object properties.

9. The cache (210) according to claim 8, wherein said cache is further characterised by said at least one business object comprising the following three types of entity: one or more lists of objects, objects, and object properties, where the three types of entity are interrelated only by data contained within the entities themselves.

10. The cache (210) according to any of preceding claims 7 to 9, wherein said cache (210) is operably coupled to an application (105) such that said cache stores data locally to the application, said cache (210) further characterised by storing at least one new data object or at least one modification to an existing data object from said application (105).

11. The cache (210) according to claim 10, wherein said cache is further characterised by storing a request from said application (105) to update one or more data objects, as an update request attached to said one or more data objects.

12. The cache (210) according to claim 10, wherein said cache is further characterised by storing a new request to update a data object, which at that time is being used to update the data store (130), as a child request of an original update request.

13. The cache (210) according to claim 12, wherein said cache is further characterised by a merging function to merge at least one additional new update request on a data object containing the original update request, provided said at least one original update request is not at that time being used to update data on said data store (130).

14. The cache (210) according to claim 7, wherein said cache is further characterised by:
means for reading the properties from the cached object;
means for applying, operably coupled to said means for reading, any updates from an attached update request to the properties and any further updates from an attached child update request to the properties; and
means for transmitting the updated object to the application.

15. A request server (225) operably coupled to a data store (130), wherein said request server (225) includes a logic function (228) to assemble business objects from data in held in said data store (130).

16. The request server (225) according to claim 15, wherein said logic function (228) is specific to said data store (130).

17. The request server (225) according to claim 15 or claim 16, wherein said logic function (228) is specific to data contained in said data store (130).

18. A cache management communications protocol running on a transport protocol within a data communication network, such that the cache management communications protocol,controls a flow of data between a request server and a cache, the cache management communication protocol supporting one or more of the following data transmission features:
(i) A data block size adjusted dependent upon a performance of said data communication network;
(ii) A data block re-transmit timer dependent upon a performance of the communication network; and/or
(iii) Objects passed between said request server and said cache at opposite ends of said cache management communications protocol using, for example, self-defining data definition such as XML notation.

19. The cache management communications protocol according to claim 18, wherein the performance of said data communication network includes one or more of the following:
(i) The available bandwidth of the network,
(ii) The loading on a communication channel,
(iii) A size of a data block transmitted, or
(iv) An amount of processing to be performed in a remote information system (240) containing said request server (225) to retrieve requested data.

20. The cache management communications protocol according to claim 18 or claim 19, wherein a re-transmit timer is adaptively adjusted, in response to on one or more time-out counters based on prevailing communication network conditions.

21. The cache management communications protocol according to claim 18 or claim 19, wherein a data block size is adaptively adjusted, in response to on one or more counters based on prevailing communication network conditions.

22. The cache management communications protocol according to claim 21, wherein a first transmitted data block is constrained to support a relatively small number of messages, in order to improve a response time for receiving data from a remote information system (240).

23. The cache management communications protocol according to claim 22, wherein said first transmitted data block size is adjusted depending on one or more of the following:
(i) A type of data request,
(ii) A preference set by a user, and
(iii) A task that a user is currently performing.

24. The cache management communications protocol according to claim 18, wherein, in response to determining that said communication network is reliable, wherein as a result of sending large data blocks:
(i) Data overhead in the transmission is substantially minimised,
(ii) A more rapid transmission is provided, and/or
(iii) A more efficient use of the communication network (155) is achieved.

25. A request server (225) adapted to operate using the cache management communications protocol according to claim 18.

26. A local information processing device (235) adapted to operate using the cache management communications protocol according to claim 18.

27. A remote information system (240) adapted to operate using the cache management communications protocol according to claim 18.

28. A communication network (200) comprising a local information processing device (235) and/or a remote information system (240) that operate(s) a transport protocol such that said local information processing device (235) and/or said remote information system (240) includes a processor to perform one or more of the following data processing functions to enable data to be transmitted using said transport protocol:
wrap a data block in one packet or, if said data block is larger than a largest data packet the transport protocol supports, in multiple packets;
route data packets from a source to a destination;
if a data block was passed in more than one packet, re-assemble said data block from its constituent packets; and
detect and delete data blocks duplicated in a communication network;
the communication network (200) characterised by:
one or both of said local information processing device (235) and said remote information system (240) estimate a likely transmission time for each data packet based on a recent communication network bit rate, and forwards said estimate to a respective user, for example a cache (210) or a request server (225).

29. The communication network (200) according to claim 28, further characterised by said local information processing device (235) and/or said remote information system (240) being configured to inform said respective user (210, 235), when transmission of a data packet commences.

30. The communication network (200) according to claim 28 or claim 29, further characterised by said processor of said local information processing device (235) and/or said remote information system (240) being configured to:
detect at least one data packet lost from at least one multi-packet data block; and
re-transmit said at least one lost data packet without involvement of said user (210, 235)

31. A request server (225) adapted to operate in the data communication network according to claim 28 or claim 29.

32. A local information processing device (235) adapted to operate in the data communication network according to claim 28 or claim 29.

33. A remote information system (240) adapted to operate in the data communication network according to claim 28 or claim 29.

34. A method (300) for a local information processing device having a cache to retrieve at least one data object from a remote information system (240) across a data network, the method comprising the step of:
requesting, for example from an application (105) operably coupled to said cache (210), a data list from said cache (210);
the method characterised by the steps of:
determining, by said cache (210), that a subset or all of said objects are contained within said cache (210); and
returning said subset number or all of said objects to said application (105) directly (340, 345) from the cache (210).

35. The method (300) for retrieving at least one data object from a remote information system (240) according to claim 34, the method further characterised by the step of:
forwarding any remaining object request, where the data object(s) is not contained within said cache, to said remote information system to retrieve said remaining data object(s).

36. The method (300) for retrieving at least one data object from a remote information system (240) according to claim 35 further characterised by the steps of:
receiving (350) said remaining object(s) from said remote information system; and
transmitting (355) said remaining object(s) to said application.

37. The method (300) for retrieving at least one data object from a remote information system (240) according to claim 34 or claim 35, wherein said step of determining includes the following steps of:
requesting, by said cache, from the remote information system (240), identifiers of substantially all objects contained in said data list requested by said application (105); and
receiving said identifiers at said cache (210), in order to make said determination.

38. The method (300) for retrieving at least one data object from a remote information system (240) according to claim 34 or claim 35, the method further characterised by the steps of:
forwarding said data list to said application (105) from said cache (210); and
transmitting, a number of individual requests (325, 330 and 335) from said application (105) to said cache (210) wherein said number of requests relate to a number of objects received in said data list, such that said step of determining is performed in response to said application requesting said number of objects.

39. The method (300) for retrieving at least one data object from a remote information system (240) according to claim 34, the method further characterised by the step of:
specifying, by said application (105), a maximum number of data object requests to be concatenated into a single cache data block to be sent to said remote information system.

40. A storage medium storing processor-implementable instructions for controlling a processor to carry out the method of claim 1 or the method of claim 34.

41. A local information processing device (235) adapted to perform any of the method steps of claim 34.

42. A cache (210) adapted to facilitate the performance of the method of the steps of claim 34.
